(19) United States
(12) Patent Application Publication
(10) Pub. No.: US 2008/0109719 A1
(43) Pub. Date: May 8, 2008

(54) Electronic Document Display Device and Method

(76) Inventors: Kazuya Osawa, Osaka (JP); Mitsuhiro Aso, Osaka (JP); Masaki Horiuchi, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/794,330

(22) PCT Filed: Sep. 28, 2005
(86) PCT No.: PCT/JP05/17805

§ 371 Date: Jun. 28, 2007

(30) Foreign Application Priority Data
Jan. 17, 2005 (JP) 2005-008782

(51) Int. Cl. G06F 17/21

(52) U.S. Cl. 715/273

(57) ABSTRACT

A keyword extraction section (108) extracts, from an electronic document (101), a plurality of character strings in accordance with information of a keyword management section (107). An action determination section (110) determines, with reference to an action definition management section (109), effect actions correlated with keywords which are corresponding to the extracted plurality of the character strings. An executing action instruction section (114) determines, from the extracted plurality of the character strings, character strings to the execute effect actions, and gives an instruction to an output control section (111). The output control section (111) controls, in accordance with the instruction given by the executing action instruction section (114), the effect actions to be executed by an output section (103).

### TECHNICAL FIELD

The present invention relates to an electronic document display device and a method, and more particularly to an electronic document display device and a method which adds, when an electronic document including a plurality of character strings representing emotional expressions is displayed on a screen, effect actions in accordance with the character strings.

### BACKGROUND ART

Transmission of an electronic document through a network such as the Internet has become very popular. Particularly, in the case of an e-mail sent and received among individuals, by adding an emotional expression to a document by using a pictograph or an emoticon, an emotion of a writer of the document is attempted to be richly expressed.

In such background, in order to enable the emotional expression of the writer of the document to be informed more clearly and effectively, a technique has been traditionally known which extracts a character string representing the emotional expression in an electronic document and adds an effect action corresponding to the character string, and displays a document on a screen of an electronic document display device (see, for example, Patent Document 1).

### Patent Document 1: Japanese Laid-Open Patent Publication No. 2000-172392

### DISCLOSURE OF THE INVENTION

### Problems to be Solved by the Invention

However, the traditional technique does not consider a case where a plurality of character strings respectively representing the emotional expressions is included in a document displayed on one screen of the electronic document display device. That is, in the case where the plurality of the character strings, to which actions conflicting with one another are to be added, is displayed on one screen of a single device, only a processing method, in which the actions added to the plurality of the character strings is executed only once or executed repeatedly in order, has been developed for the electronic document display device of the traditional technique. Therefore, there has been a problem in which a description displayed on the screen does not correspond to an additional action being executed, which makes it difficult, by contraries, to understand an emotional expression.

Therefore, an object of the present invention is to provide an electronic document display device and a method which is capable of appropriately displaying, on a screen, an electronic document including the plurality of the character strings representing the emotional expressions and accompanied by additional actions.

### Solution to the Problems

The present invention is directed to an electronic document display device which displays an electronic document on a screen of an output device. To achieve the above object, the electronic document display device of the present invention includes a keyword management section, a keyword extraction section, an action definition management section, an action determination section, an executing action instruction section, and an output control section.

The keyword management section retains a plurality of keywords. The keyword extraction section extracts, from one screenful of the electronic document to be displayed on the output device, character strings corresponding to the plurality of the keywords retained by the keyword management section. The action definition management section retains effect actions, which defines actions to be executed by an output device, by correlating the same with the plurality of the keywords retained by the keyword management section. The action determination section determines, with reference to the action definition management section, the effect actions of the character strings extracted from the electronic document by the keyword extraction section. The executing action instruction section gives an instruction to execute the effect actions determined by the action determination section in accordance with predetermined priority processing. The output control section controls an action of the output device and executes the effect actions instructed by the executing action instruction section as well as a screen display of the electronic document.

Preferably, the action definition management section further retains priority levels previously provided to the plurality of the keywords retained in the keyword management section, and the executing action instruction section gives an instruction to the output control section so as to execute only an effect action of a highest priority level. Alternatively, the executing action instruction section may give an instruction to the output control section so as to execute only an effect action of the character string which initially appears on one screen. Alternatively, the executing action instruction section may prioritize the character strings appearing on one screen in order of appearance thereof, and give an instruction to the output control section so as to execute the effect actions thereof respectively only once or repeatedly in descending order of priority. Further, it is desirable to include an electronic document display instruction section for determining, in one screen, a position of a character string which appears secondarily on the one screen, and giving an instruction to the output control section so as to execute a page break from a line including the character string which appears secondarily or to execute a page break from a first character of the character string which appears secondarily.

Processing performed by respective configurations of the above-described electronic document display device may be regarded as an electronic document display method for providing a series of processing procedures. The method is provided in a form of a program to cause a computer to execute the series of the processing procedures. The program may be stored in the computer in a form recorded on a computer readable recording medium. Further, functional blocks of the keyword extraction section, the action determination section, the executing action instruction section, and the output control section all of which composing the above-described electronic document display device may be realized as an LSI, which is an integrated circuit.

### Effect of the Invention

As above described, according to the present invention, even in the case where the plurality of the keywords, which is included in the electronic document and defined by the effect actions, are displayed on the one screen of the display device concurrently, a conflict between the effect actions can be avoided by utilizing priority levels of the keywords. Further, according to the present invention, it is also possible to display the plurality of the keywords, which is included in the electronic document and defined by the effect actions, on the one screen of the display device concurrently, whereby it is possible to avoid the conflict between the effect actions.

### BRIEF DESCRIPTION OF THE DRAWINGS

FIG. 1 is a block diagram illustrating a configuration of an electronic document display device 10 according to a first embodiment of the present invention.

FIG. 2 is a flowchart showing a procedure of an electronic document display method executed by the electronic document display device 10 according to the first embodiment of the present invention.

FIG. 3 is a diagram showing an example of information managed by the keyword management section 107.

FIG. 4 is a diagram showing an example of information managed by the action definition management section 109.

FIG. 5 is a diagram showing an example of information extracted by the keyword extraction section 108.

FIG. 6 is a diagram showing an example of information determined by the action determination section 110.

FIG. 7 is a specific example showing an action of viewing an e-mail in the case where the electronic document display device 10 is a cellular phone.

FIG. 8 is a block diagram showing a configuration of an electronic document display device 20 according to a second embodiment of the present invention.

FIG. 9 is a flowchart illustrating a procedure of an electronic document display method executed by the electronic document display device 20 according to the second embodiment.

FIG. 10 is a specific example showing an action of viewing an e-mail in the case where the electronic document display device 20 is a cellular phone.

FIG. 11 is another specific example showing an action of viewing an e-mail in the case where electronic document display device 20 is a cellular phone.

### DESCRIPTION OF THE REFERENCE CHARACTERS

101 electronic document

102 display unit

103 output section

104 beeping unit

105 vibratory unit

106 luminescent unit

107 keyword management section

108 keyword extraction section

109 action definition management section

110 action determination section

111, 211 output control section

113, 213 display screen update request monitoring section

114, 214 executing action instruction section

212 electronic document display instruction section

### BEST MODE FOR CARRYING OUT THE INVENTION

### First Embodiment

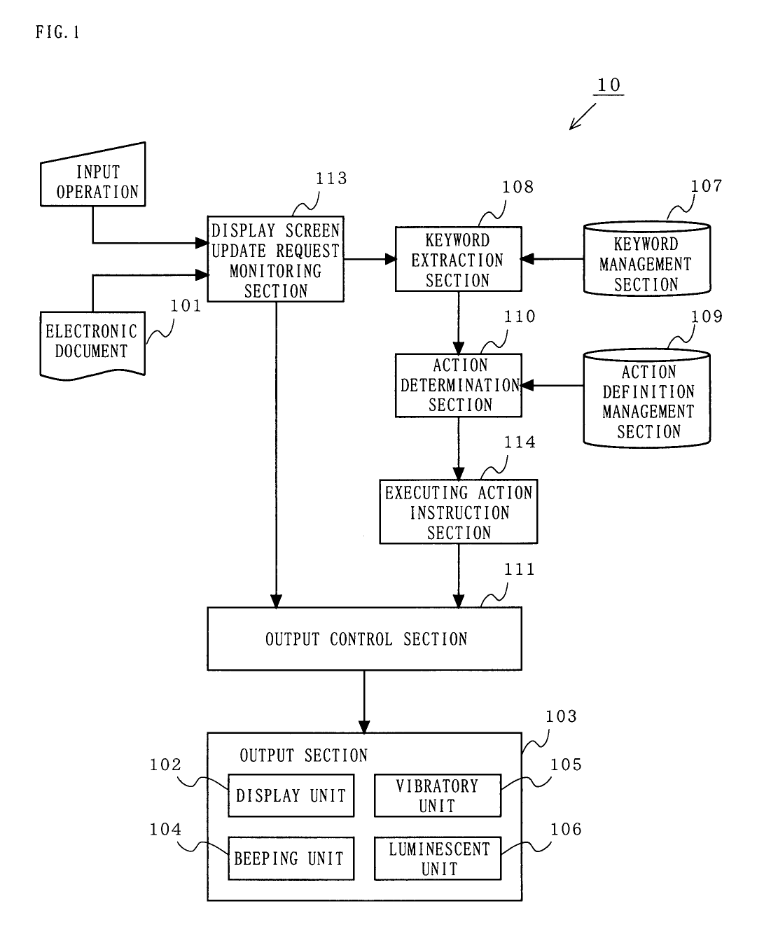

FIG. 1 is a block diagram illustrating a configuration of an electronic document display device 10 according to a first embodiment of the present invention. In FIG. 1, the electronic document display device 10 according to the first embodiment includes a display screen update request monitoring section 113, a keyword extraction section 108, a keyword management section 107, an action determination section 110, an action definition management section 109, an executing action instruction section 114, an output control section 111, and an output section 103.

The output section 103 includes a display unit 102 (a display such as a liquid crystal, an LCD, and a CRT) displaying an electronic document 101 on a screen, a beeping unit 104 (such as a speaker) generating voice/music or sound such as a beep sound, a vibratory unit 105 (such as a vibrator) generating vibration (including intermittent or strong/weak one) and a luminescent unit 106 (such as a backlight of a display screen or another LCD light) emitting light. The output section 103 does not necessarily include the above-described four units, and may include at least the display unit 102.

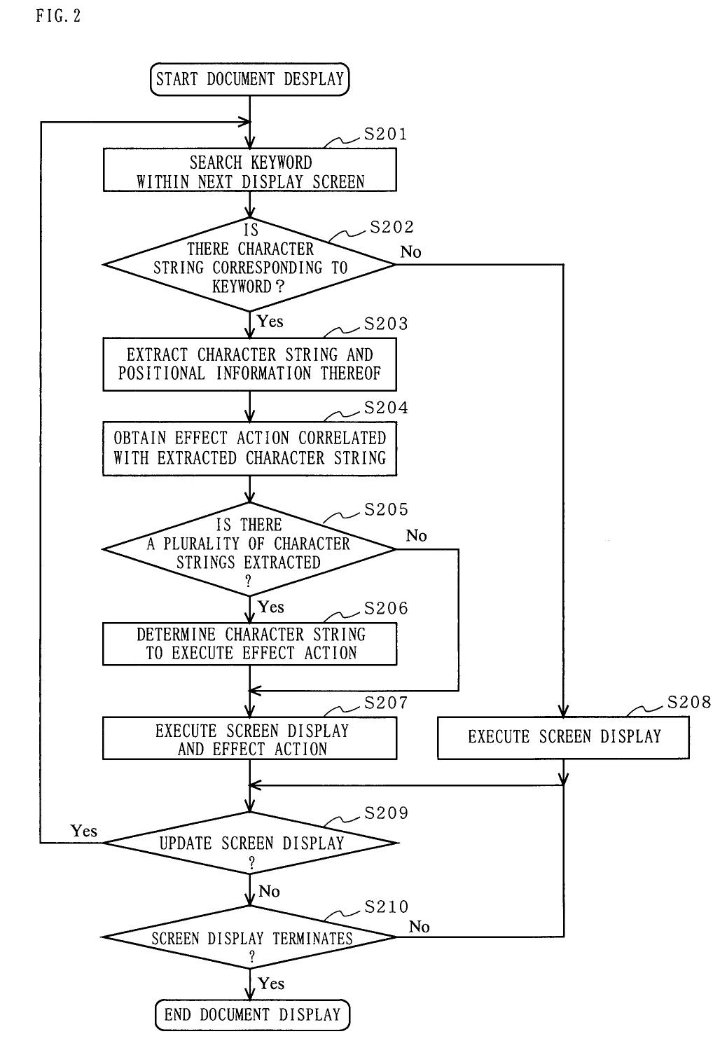

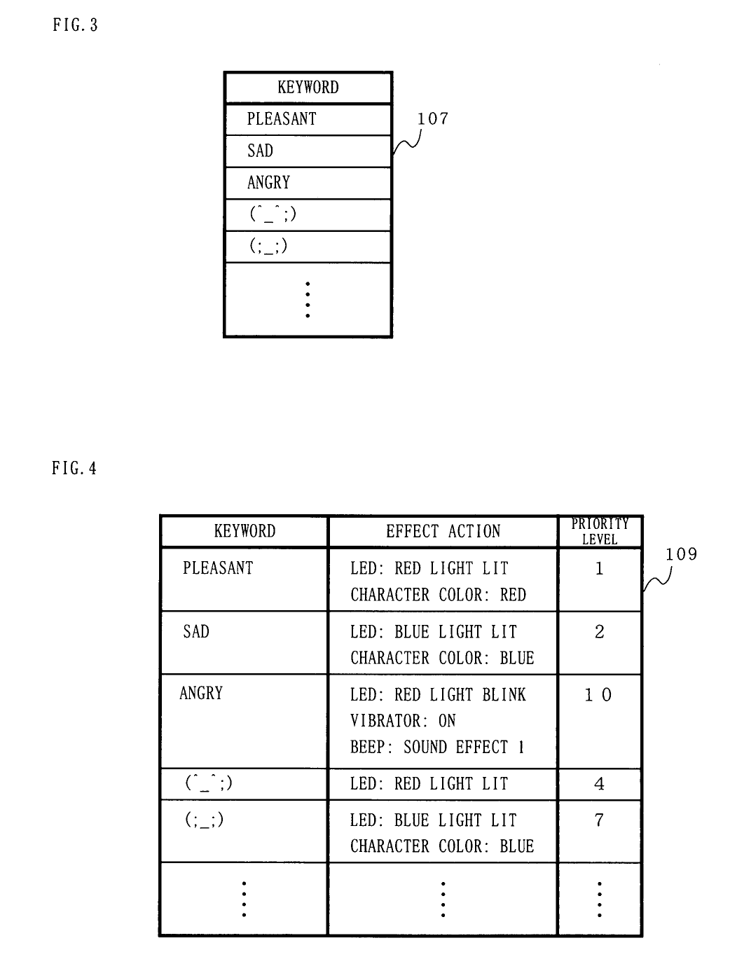

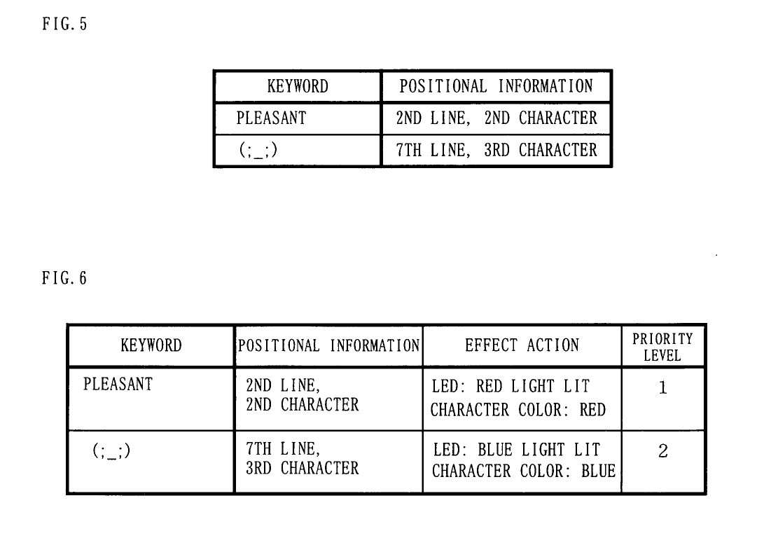

Hereinafter, the electronic document display device 10 having the above-described configuration according to the first embodiment will be described, further with reference to FIG. 2 to FIG. 6. FIG. 2 is a flowchart showing a procedure of an electronic document display method executed by the electronic document display device 10 according to the first embodiment of the present invention. FIG. 3 is a diagram showing an example of information managed by the keyword management section 107. FIG. 4 is a diagram showing an example of information managed by the action definition management section 109. FIG. 5 is a diagram showing an example of information extracted by the keyword extraction section 108. FIG. 6 is a diagram showing an example of information determined by the action determination section 110.

The electronic document 101, which is a display target, is an e-mail, a web page, various documents stored in a computer, or the like, and for example, corresponds to normal text data such as an e-mail main body and a chat message main body, and content data including a markup language. In the electronic document 101, a plurality of character strings respectively representing emotional expressions and accompanied by additional actions is included. Here, each of the character strings represents an expression including a character, a pictograph, a symbol, a figure, and a combination of several thereof (an emoticon, etc.).

When an electronic document viewer starts displaying the electronic document 101, the display screen update request monitoring section 113 inputs the electronic document 101 and a screen operation which is instructed by the electronic document viewer or controlled by an automatic viewing function. The screen operation is an operation such as a page scroll, a line scroll, and a jump, and also corresponds to an update request to change/relocate a content of an electronic document currently displayed on a display screen of the display unit 102. That is, in the case where a whole text of the electronic document 101 cannot be displayed on the screen for reasons such as smallness of the display screen of the display unit 102, the operation is performed such that the electronic document 101 can be viewed sequentially. The display screen update request monitoring section 113 then outputs, in accordance with the screen operation, a range of data of the electronic document 101, which is to be displayed next on the screen of the display unit 102, to the keyword extraction section 108 and to the output control section 111. The electronic document 101 is initially displayed from a beginning of the electronic document 101.

The keyword extraction section 108 extracts, in accordance with the information of the keyword management section 107, character strings from one screenful of the electronic document 101 provided by the display screen update request monitoring section 113. As shown in FIG. 3, in the keyword management section 107, a plurality of keywords specifying the character strings to be extracted from the electronic document 101 are previously registered. That is, the keyword extraction section 108 searches the one screenful of the electronic document 101 to be displayed next (step S201) to determine whether or not the character strings corresponding to the keywords are included therein (step S202). In the case where the character strings corresponding to the keywords are included in the one screenful of the electronic document 101, the keyword extraction section 108 extracts positional information which indicates positions where the respective character strings (the keywords) appear in the electronic document 101, and then prepares the information as shown in FIG. 5 (step S203). FIG. 5 is an example in which a line number and a character number from the beginning of a document are used as the positional information. The information prepared by the keyword extraction section 108 is notified to the action determination section 110.

The action determination section 110 determines, upon reception of a notification of the information from the keyword extraction section 108, effect actions to be done by the output section 103 in accordance with the keywords. As shown in FIG. 4, with regard to the plurality of the keywords registered in the keyword management section 107, effect actions respectively corresponding to the keywords are previously defined in the action definition management section 109. The number of the effect actions corresponding to one keyword is not limited to one, and a plurality of the effect actions may be defined as long as can be performed concurrently in the output section 103. In the example of FIG. 4, a keyword “pleasant” is defined by a red LED lit by the luminescent unit 106, and also by a screen display in red characters by the display unit 102. Further, a priority level is provided to each of the keywords. The priority level is information used to determine an order of the effect actions executed by the output section 103. That is, the action determination section 110 determines, with reference to the action definition management section 109, the effect action and the priority level of each of the keywords indicated by the information, and prepares the information as shown in FIG. 6 (step S204). The information prepared by the action determination section 110 is notified to the executing action instruction section 114.

The executing action instruction section 114 determines, upon reception of a notification of the information from the action determination section 110 and based on the information, whether or not a plurality of the keywords is included in the one screenful of the electronic document 101 (step S205). In the case where only one keyword is included, the executing action instruction section 114 gives an instruction to the output control section 111 so as to execute an effect action of the keyword provided as action information (step S207). On the other hand, in the case where two or more keywords are included, the executing action instruction section 114 selects a keyword of a highest priority level, with reference to the priority level of each of the keywords provided as the action information (step S206). The executing action instruction section 114 then gives an instruction to the output control section 111 so as to execute an effect action of the selected keyword (step S207).

The output control section 111 processes data of the one screenful of the electronic document 101 provided by the display screen update request monitoring section 113 so as to change/relocate (update) the display screen, and also controls the output section 103 in accordance with the instruction to execute the action effects given by the executing action instruction section 114. In the case where it is determined, in the above described step S202, that no one keyword is included, the output control section 111 processes the data of the one screenful of the electronic document 101 so as to only change/relocate the display screen (step S208).

The above-described processing is repeatedly performed while the screen operation is instructed by the electronic document viewer (step S209), and is terminated, for example, upon reception of an instruction indicating completion of viewing of the electronic document 101 (step S210).

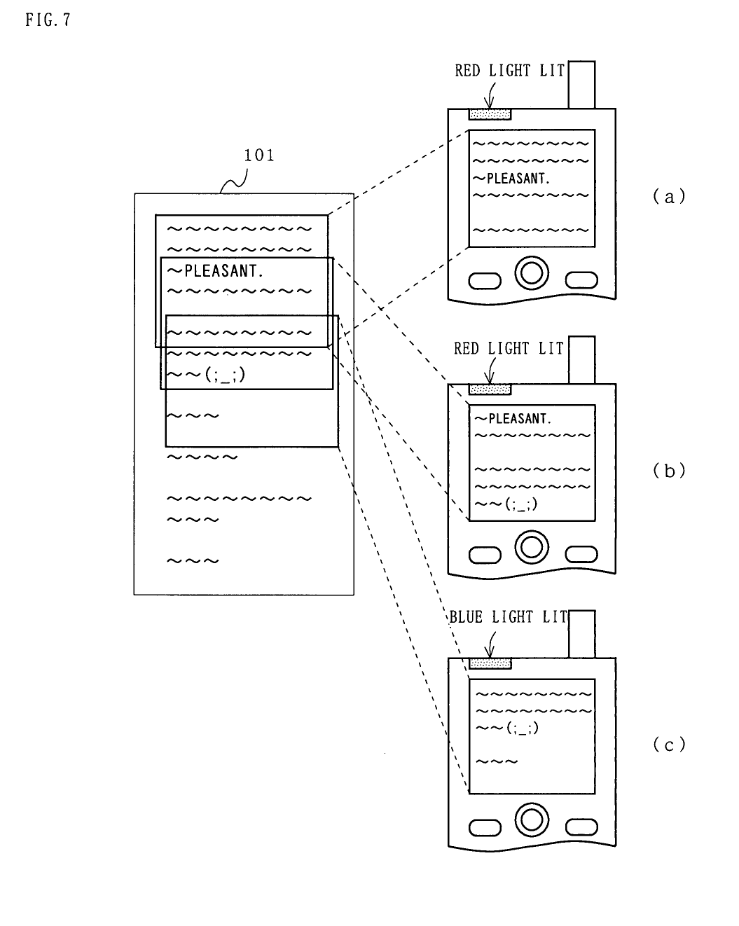

FIG. 7 is a specific example showing an action of viewing an e-mail (electronic document 101) in the case where the electronic document display device 10 is a cellular phone. In this example, in the case where keywords “pleasant” and “(;_;)” are displayed on one screen, the case which occurs in the process of screen scrolling (FIG. 7(b)), an effect action corresponding to a higher-priority keyword “pleasant” will be executed (see FIG. 4)

As above described, according to the electronic document display device 10 according to the first embodiment of the present invention, even in the case where the plurality of the keywords which is included in the electronic document 101 and defined by the effect actions are concurrently displayed on the one screen of the display device, a conflict between the effect actions can be avoided by utilizing the priority level of each of the keywords.

In the above-described embodiment, a method of selecting one keyword of the highest priority level, in the case where there is the plurality of the keywords displayed on the one screen, is described. However, in the case where the plurality of the keywords is such keywords that are defined by effect actions whose output forms in the output section 103 do not conflict with one another (for example, the vibratory unit 105 and the luminescent unit 106), the effect actions may be executed regardless of the priority level. Further, instead of selecting one keyword of the highest priority level, it may be possible to execute the effect actions of the plurality of keywords in descending order of priority once or repeatedly at a predetermined interval.

Further, in the above-described embodiment, a case where the priority level of each of the keywords is previously registered in a fixed manner in the action definition management section 109 is described. However, the priority level may be determined in accordance with a description of the electronic document 101 to be displayed. For example, a priority level order of the keywords may be determined according to the number of times of appearance thereof in the electronic document 101, or the priority level order of the keywords may be determined in accordance with an appearing position thereof from a beginning of a text of the electronic document 101.

### Second Embodiment

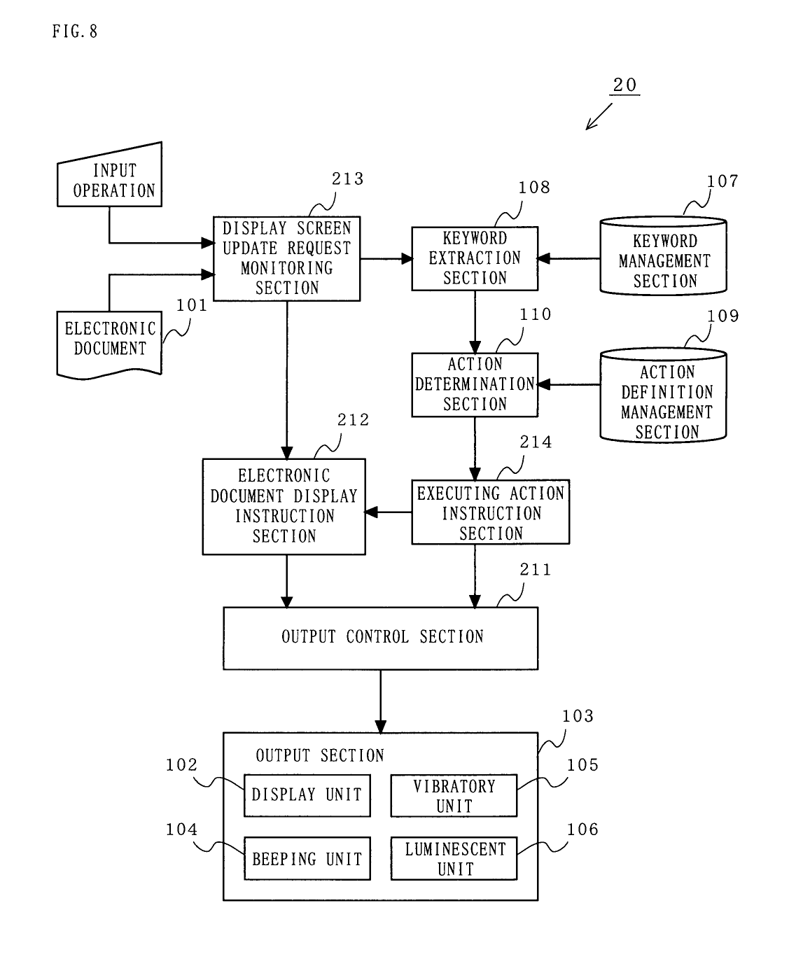

FIG. 8 is a block diagram showing a configuration of an electronic document display device 20 according to a second embodiment of the present invention. In FIG. 8, the electronic document display device 20 according to the second embodiment includes, a display screen update request monitoring section 213, a keyword extraction section 108, a keyword management section 107, an action determination section 110, an action definition management section 109, an executing action instruction section 214, an electronic document display instruction section 212, an output control section 211, and an output section 103.

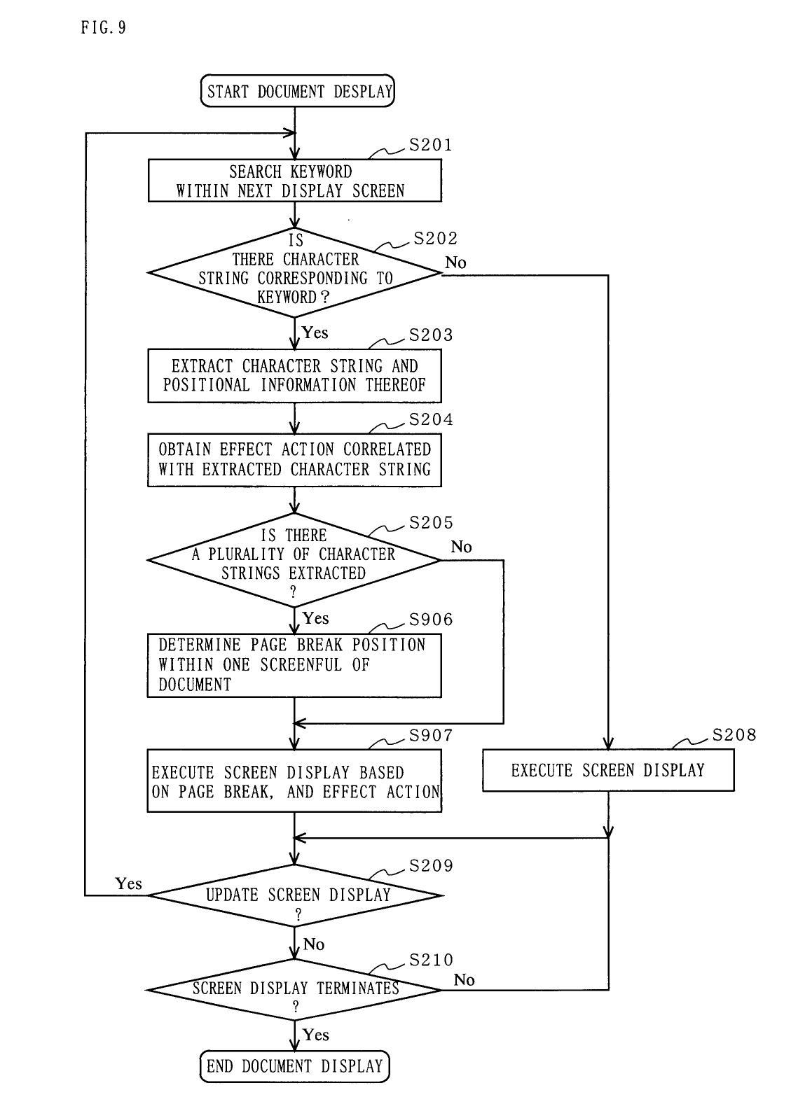

As is known from FIG. 8, the electronic document display device 20 according to the second embodiment is different in a configuration of the display screen update request monitoring section 213, the executing action instruction section 214, the electronic document display instruction section 212 and the output control section 211, from the electronic document display device 10 according to the first embodiment. Hereinafter, the electronic document display device 20 according to the second embodiment will be described by focusing on such different component parts. FIG. 9 is a flowchart illustrating a procedure of an electronic document display method executed by the electronic document display device 20 according to the second embodiment.

When an electronic document viewer starts displaying an electronic document 101, the display screen update request monitoring section 213 inputs the electronic document 101 and a screen operation instructed by the electronic document viewer. The display screen update request monitoring section 213 then outputs, in accordance with the screen operation, a range of data of the electronic document 101 which is to be displayed next on one screen of the display unit 102, to the keyword extraction section 108 and to the electronic document display instruction section 212. The electronic document 101 is initially displayed from a beginning of the electronic document 101.

The keyword extraction section 108 searches, in accordance with the information of the keyword management section 107 (see FIG. 3), one screenful of the electronic document 101 provided by the display screen update request monitoring section 213 (step S201) and determines whether or not character strings corresponding to keywords are included (step S202). In the case where the character strings corresponding to the keywords are included in the one screenful of the electronic document 101, the keyword extraction section 108 extracts positional information which indicates positions where the respective character strings (keywords) appear in the electronic document 101, and then prepares the information as shown in FIG. 5 (step S203). The information prepared by the keyword extraction section 108 is notified to the action determination section 110.

The action determination section 110 determines, upon reception of a notification of the information from the keyword extraction section 108, an effect action and a priority level of each of the keywords, with reference to a plurality of keywords which is registered in the keyword management section 107, and prepares the information as shown in FIG. 6 (step S204). The information prepared in the action determination section 110 is notified to the executing action instruction section 114.

Upon reception of a notification of the information from the action determination section 110, the executing action instruction section 214 determines, based on the information, whether or not a plurality of keywords is included in the one screenful of the electronic document 101 (step S205). In the case where only one keyword is included, the executing action instruction section 214 gives an instruction to the output control section 211 to execute effect actions of the keyword provided as action information (step S207). On the other hand, in the case where two or more keywords are included, the executing action instruction section 214 determines a page break position in the electronic document 101 such that there is one keyword displayed on one screen (step S906). The page break position is determined based on second positional information from the head of the screen, among the positional information relating to each of the keywords extracted by the keyword extraction section 108. Specifically, in the case where the second positional information from the head of the screen is located at “an M-th line, an N-th character”, the page break position is set after the last character in an M-1-th line, or the page break position is set after an N-1-th character in the M-th line. The executing action instruction section 214 then gives an instruction indicating the determined page break position to the electronic document display instruction section 212, and so as to execute an effect action of a keyword which initially appears on the one screen (a keyword having first positional information from the head of the screen) to the output control section 211 (step S907).

The electronic document display instruction section 212 processes the data of the one screenful of the electronic document 101 provided by the display screen update request monitoring section 213 in accordance with the page break position instructed by the executing action instruction section 214, and outputs the data of the one screenful of the electronic document 101 processed with the page break to the output control section 211 (step S907).

The output control section 211 processes the data of the one screenful of the electronic document 101, which is processed with the page break and provided by the electronic document display instruction section 212, so as to change/relocate (update) a display screen, and also controls the output section 103 in accordance with an instruction to execute the effect actions given by the executing action instruction section 214. In the case where it is determined that no one keyword is included in the above-described step S202, the output control section 211 processes the data of the one screenful of the electronic document 101 so as to only change/relocate the display screen (step S208).

The above-described processing is repeatedly performed while the screen operation is instructed by the electronic document viewer (step S209), and is terminated, for example, upon reception of an instruction indicating completion of viewing of the electronic document 101 (step S210).

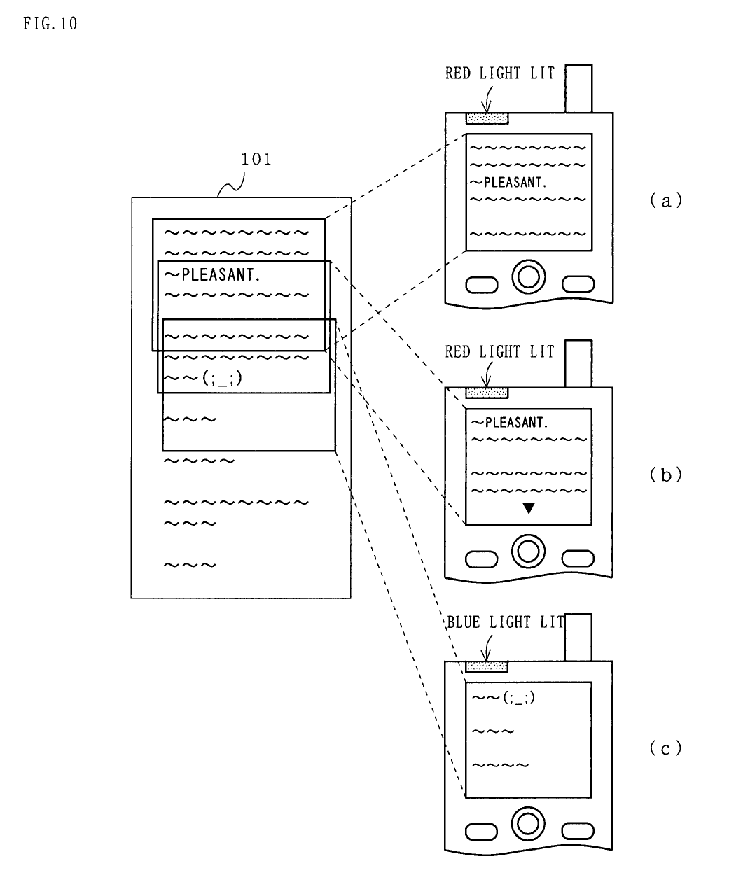

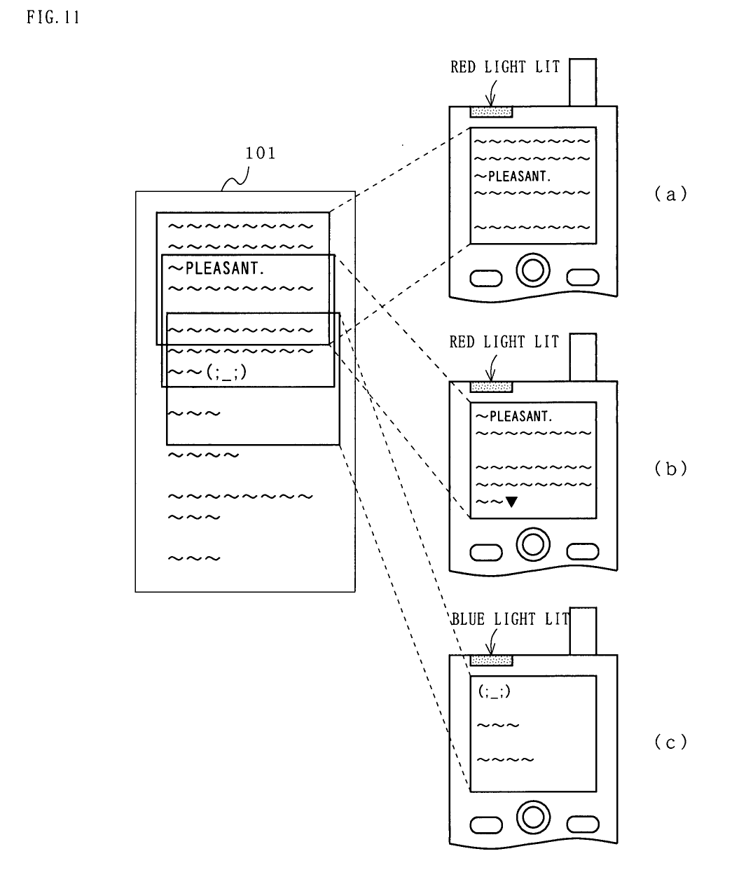

FIG. 10 and FIG. 11 are specific examples each of which shows an action of viewing an e-mail (electronic document 101) in the case where the electronic document display device 10 is a cellular phone. In this manner, in the second embodiment, there is no case where keywords “pleasant” and “(;_;)” are displayed in a single screen, the case which occurs in the above-described first embodiment, and the page break is executed on a line basis (FIG. 10) or on a character basis (FIG. 11).

As above described, according to the electronic document display device 20 according to the second embodiment of the present invention, the plurality of the keywords which is included in the electronic document 101 and defined by the effect actions is not displayed on the one screen of the display device concurrently, whereby it is possible to avoid a conflict between the effect actions.

In each of the above embodiments, the keyword management section 107 and the action definition management section 109 are respectively described as independent configurations, but may be considered as a single configuration. Further, the information managed by the keyword management section 107 and the action definition management section 109 may be arranged per electronic document to be viewed. Here, if results of keyword extraction and action determination which are performed at the beginning are correlated with the electronic document 101 and then stored, it is possible, when the electronic document 101 is viewed later, to skip the corresponding keyword extraction and the action determination, and immediately give an instruction of executing a screen display, whereby a processing load of the device will be reduced.

Further, it is preferable to allow the information managed by the keyword management section 107 and the action definition management section 109 to be added and deleted freely. In this case, addition and an deletion of the information in the keyword management section 107 and the action definition management section 109 may be performed directly by hand by the electronic document viewer, or automatically according to the information attached to the electronic document 101. In the latter case, it is possible to cause a counterpart to view the electronic document 101 in line with an intention of a writer of a document.

Further, in the case where one keyword is defined by a plurality of the effect actions in the action definition management section 109, the output section 103 may execute only available effect actions. For example, in the case of viewing the electronic document 101 during listening to the music, there may be a case where the beeping unit 104 cannot be used. In such case, effect actions of a specific keyword may be executed by using any other devices than the beeping unit 104.

The above-described embodiments are realized by causing a CPU to interpret and execute predetermined program data which can execute the above-described processing procedure stored in a storage device (such as a ROM, a RAM, and a hard disc). In this case, the program data may be executed after it is stored in the storage device via a recoding medium, or may be directly executed from the recording medium. Note that the recording medium includes a ROM, a RAM, a semiconductor memory such as a flash memory, a magnetic disc memory such as a flexible disc and a hard disc, an optical disc memory such as a CD-ROM, a DVD, and a BD, a memory card, or the like. Further, the recording medium is a notion including a communication medium such as a telephone line and a carrier line.

Further, functional blocks of the keyword extraction section 108, the action determination section 110, and the executing action instruction section 114 or 214 composing the electronic document display device of the present invention are typically realized as an LSI, which is an integrated circuit (which may be referred to as an IC, a system LSI, a super LSI, or an ultra LSI, etc., depending on the degree of integration). These may be separately constructed in a chip form, or all or some thereof may be constructed in a chip form.

Further, the method of the integration is not limited to the LSI, and may be realized by a dedicated circuit or a general purpose processor. Further, it may be possible to use an FPGA (Field Programmable Gate Array) which is an LSI programmable after manufacturing, or a reconfigurable processor enabling connections and settings of the circuit cells in the LSI to be reconfigured.

Further, in the case where another integration technology replacing the LSI becomes available due to improvement of a semiconductor technology or due to the emergence of another technology derived therefrom, integration of the functional blocks may be naturally performed using such a new technology. For example, biotechnology may be applied.

### INDUSTRIAL APPLICABILITY

The present invention is applicable to a computer, a cellular phone, a handheld terminal, an audio-visual device, a digital camera, and a household electrical appliance, etc. all of which are capable of displaying an electronic document, and particularly useful for a case where the electronic document including a plurality of character strings accompanied by additional actions and representing emotional expressions is to be displayed appropriately on a screen.

1. An electronic document display device for displaying an electronic document on a screen of an output device, the electronic document display device comprising:
a keyword management section for retaining a plurality of keywords;
a keyword extraction section for extracting, from one screenful of the electronic document to be displayed on the output device, character strings corresponding to the plurality of the keywords retained by the keyword management section;
an action definition management section for retaining effect actions, which defines actions to be executed by an output device, by correlating the same with the plurality of the keywords retained by the keyword management section;
an action determination section for determining, with reference to the action definition management section, the effect actions of the character strings extracted from the electronic document by the keyword extraction section;
an executing action instruction section for giving an instruction to execute the effect actions determined by the action determination section in accordance with predetermined priority processing; and
an output control section for controlling an action of the output device and for executing the effect actions instructed by the executing action instruction section as well as a screen display of the electronic document.

2. The electronic document display device according to claim 1, wherein
the action definition management section further retains priority levels previously provided to the plurality of the keywords retained in the keyword management section, and
the executing action instruction section gives an instruction to the output control section so as to execute only an effect action of a highest priority level.

3. The electronic document display device according to claim 1, wherein the executing action instruction section gives an instruction to the output control section so as to execute only an effect action of a character string which initially appears on one screen.

4. The electronic document display device according to claim 1, wherein the executing action instruction section prioritizes the character strings appearing on one screen in order of appearance thereof, and gives an instruction to the output control section so as to execute the effect actions respectively only once in descending order of priority.

5. The electronic document display device according to claim 1, wherein the executing action instruction section prioritize the character strings appearing on one screen in order of appearance thereof, and gives an instruction to the output control section so as to execute the effect actions thereof repeatedly in descending order of priority.

6. The electronic document display device according to claim 1 further comprising an electronic document display instruction section for determining, in one screen, a position of a character string which appears secondarily on the one screen, and for giving an instruction to the output control section so as to execute a page break from a line including the character string which appears secondarily.

7. The electronic document display device according to claim 1 further comprising an electronic document display instruction section for determining, in one screen, a position of a character string which appears secondarily on the one screen, and for giving an instruction to the output control section so as to execute a page break from a first character of the character string which appears secondarily.

8. An electronic document display method for displaying an electronic document on a screen of an output device, the electronic document display method utilizing
a keyword management section for retaining a plurality of keywords, and an action definition management section for retaining effect actions, which defines actions to be executed by an output device, by correlating the same with the plurality of the keywords retained by the keyword management section, the electronic document display method comprising:
a step of extracting, from one screenful of the electronic document to be displayed in the output device, character strings corresponding to the plurality of the keywords retained by the keyword management section;
a step of determining, with reference to the action definition management section, the effect actions of the character strings extracted from the electronic document;
a step of giving an instruction to execute the determined effect actions in accordance with predetermined priority processing; and
a step of controlling an action of the output device and of executing the instructed effect actions as well as a screen display of the electronic document.

9. A computer readable program for causing a computer to execute an electronic document display method for displaying an electronic document on a screen of an output device, the computer readable program utilizing
a keyword management section for retaining a plurality of keywords, and an action definition management section for retaining effect actions, which define actions to be executed by an output device, by correlating the same with the plurality of the keywords retained by the keyword management section, the computer readable program causing the computer to execute:
a step of extracting, from one screenful of the electronic document to be displayed in the output device, character strings corresponding to the plurality of the keywords retained by the keyword management section;
a step of determining, with reference to the action definition management section, the effect actions of the character strings extracted from the electronic document;
a step of giving an instruction to execute the determined effect actions in accordance with predetermined priority processing; and
a step of controlling an action of the output device and of executing the instructed effect actions as well as a screen display of the electronic document.

10. An integrated circuit which is used in an electronic document display device which displays an electronic document on a screen of an output device, the integrated circuit being incorporated in
the electronic document display device which includes a keyword management section for retaining a plurality of keywords, and an action definition management section for retaining effect actions, which define actions to be executed by an output device, by correlating the same with the plurality of the keywords retained by the keyword management section, the integrated circuit functioning as:
a keyword extraction section for extracting, from one screenful of the electronic document to be displayed on the output device, character strings corresponding to the plurality of the keywords retained by the keyword management section;
an action determination section for determining, with reference to the action definition management section, the effect actions of the character strings extracted from the electronic document by the keyword extraction section;
an executing action instruction section for giving an instruction to execute the effect actions determined by the action determination section in accordance with predetermined priority processing; and
an output control section for controlling an action of the output device and for executing the effect actions instructed by the executing action instruction section as well as a screen display of the electronic document.
